(19) United States
(12) Patent Application Publication
(10) Pub. No.: US 2013/0321528 A1
(43) Pub. Date: Dec. 5, 2013

(54) LIQUID DISCHARGE HEAD AND LIQUID DISCHARGE APPARATUS

(71) Applicant: CANON KABUSHIKI KAISHA, Tokyo (JP)

(72) Inventors: Naoko Tsujiuchi, Kawasaki-shi (JP); Kiyomitsu Kudo, Machida-shi (JP); Tomotsugu Kuroda, Yokohama-shi (JP)

(73) Assignee: CANON KABUSHIKI KAISHA, Tokyo (JP)

(21) Appl. No.: 13/903,844

(22) Filed: May 28, 2013

(30) Foreign Application Priority Data
May 31, 2012 (JP) 2012-124834

(51) Int. Cl. B41J 2/135

(52) U.S. Cl. CPC B41J 2/135
USPC 347/37

(57) ABSTRACT

The invention stabilizes a posture of a liquid discharge head when mounting the liquid discharge head with respect to a mount section of a liquid discharge apparatus and improves the mountability thereof. The liquid discharge head includes a grasp portion provided with a surface extending along a first direction as a direction of disposition of a plurality of discharge ports and extending along a second direction intersecting the discharge port surface and used for grasping the liquid discharge head. The surface of the grasp portion is provided at a position not overlapped in the direction vertical to the discharge port surface with a center axis passing in a third direction which is vertical to the first direction and extending along the discharge port surface through the center of gravity of the liquid discharge head in the first direction.

### BACKGROUND OF THE INVENTION

1. Field of the Invention

The present disclosure relates to a liquid discharge head configured to discharge liquid and a liquid discharge apparatus.

2. Description of the Related Art

A liquid discharge head (hereinafter, referred to also as “head”) mounted on a liquid discharge apparatus (hereinafter, referred to also as “apparatus main body”) generally has a demountably mountable configuration with respect to a mount section of the apparatus main body. A liquid discharge head described in Japanese Patent Laid-Open No. 2010-18030 has a configuration in which side walls of a tank holder are used as grasp portions to be used by a user for grasping the head when the user mount the head on the apparatus main body. Since the surface area that the user can grasp is increased by increasing the surface area of the side walls as the grasp portion to be a surface area larger than a predetermined surface area, that is, a surface area larger than the surface area of a partitioning wall that partitions between tanks, the user is capable of grasping the head easily.

When mounting the head on the apparatus main body, there is a case where the head is mounted in a state of being inclined more than a posture in use thereof, which is a posture when being mounted completely. For example, there is a known configuration in which an upper portion of the head is fixed by holding with a holding member provided on the apparatus main body in order to achieve accurate positioning between an liquid discharge portion of the head and recording medium such as paper by ensuring contact a positioning portion between the head and the apparatus main body. Since the holing member is located above the mount section, when mounting the head on the apparatus main body, the head is mounted in an inclined posture so as not to interfere with the holding member.

However, the direction of inclination of the head varies with the positional relationship between the grasp portion and the center of gravity of the head depending on which portion of the grasp portion of the head the user grasps. In particular, when the weight of the head is large, the posture of the head is susceptible to the positional relationship between the grasp position of the grasp portion and the position of the center of gravity of the head.

In this manner, when the direction of inclination varies with the grasp position of the head where the user grasps, the head may have difficulty in mounting the head. In addition, there is a probability that the head is inclined in a direction opposite to a posture suitable for mounting and, in this case, the head may collide with the interior of the apparatus main body and hence mounting of the head may not be performed smoothly.

### SUMMARY OF THE INVENTION

The invention, among other things, stabilizes a posture of a liquid discharge head when mounting the liquid discharge head with respect to a mount section of a liquid discharge apparatus and improves the mountability thereof.

A liquid discharge head of the application is a liquid discharge head having a discharge port surface in which a plurality of discharge ports configured to discharge liquid are disposed along a first direction, including a grasp portion including a surface extending along the first direction and a second direction intersecting the discharge port surface and used for grasping the liquid discharge head, and the surface of the grasp portion is provided at a position not overlapped with a center axis passing through the center of gravity of the liquid discharge head in the first direction along a third direction which is vertical to the first direction and extending along the discharge port surface in the direction vertical to the discharge port surface.

According to the disclosure, when a user grasps the liquid discharge head at the grasp portion, the liquid discharge head is included in a definite direction irrespective of a grasp position of the grasp portion. Accordingly, a posture of the liquid discharge head when mounting the liquid discharge head with respect to a mount section of the liquid discharge apparatus is stabilized and the mountability thereof is improved.

Further features of the present invention will become apparent from the following description of exemplary embodiments with reference to the attached drawings.

### BRIEF DESCRIPTION OF THE DRAWINGS

FIGS. 1A and 1B are perspective views of an ink jet head.

FIGS. 2A to 2D are schematic drawings for explaining mounting of the ink jet head of a first embodiment on a mount section of an ink jet recording apparatus.

FIGS. 3A to 3C are schematic cross-sectional views of the ink jet head of the first embodiment taken along a plane including a grasp portion.

FIGS. 4A to 4C are drawings illustrating a comparative example of the first embodiment.

FIG. 5 is a schematic drawing of the ink jet head of the first embodiment when viewed in a sub-scanning direction from the near side of the head.

FIGS. 6A to 6C are schematic drawings illustrating an ink jet head of a second embodiment.

FIG. 7 is a schematic cross-sectional view of the ink jet head of the second embodiment taken along the plane including the grasp portion.

FIGS. 8A to 8C are drawings illustrating the ink jet head of a third embodiment.

FIG. 9 is a perspective view of an ink jet recording apparatus.

### DESCRIPTION OF THE EMBODIMENTS

Embodiments of the invention will be described below.

### First Embodiment

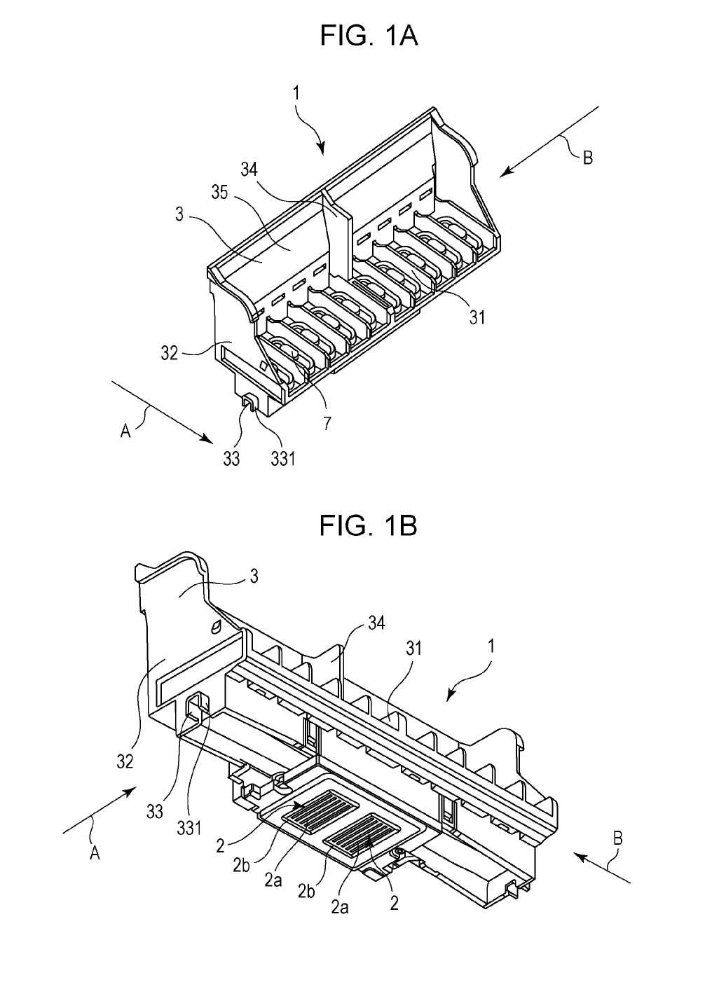

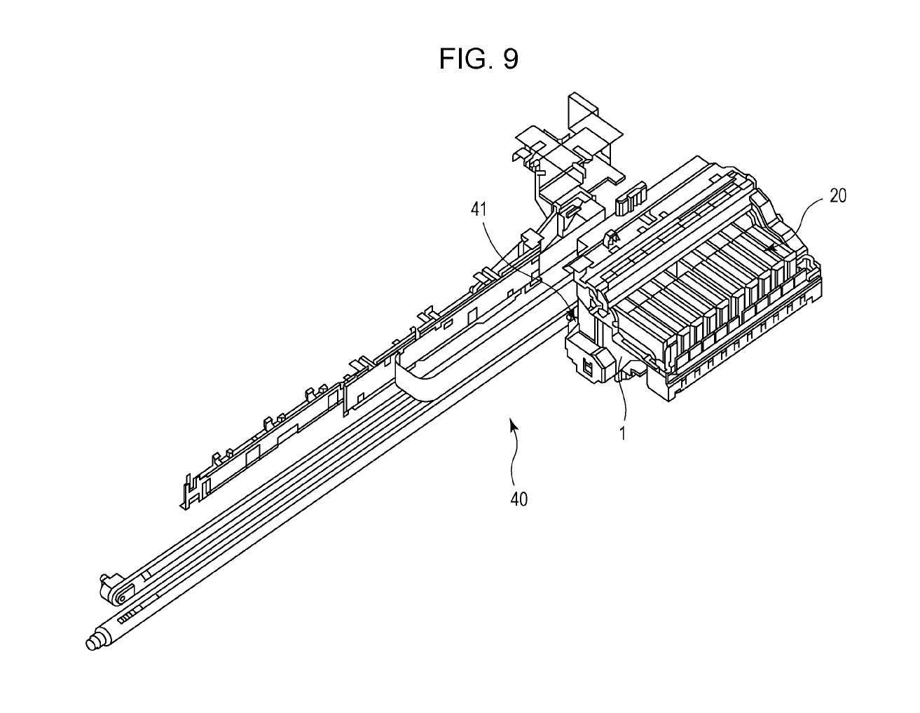

FIG. 1A illustrates a perspective view of an ink jet head 1 as a liquid discharge head of a first embodiment viewed from the side of a tank holder. FIG. 1B is a perspective view of the ink jet head 1 when viewed from the side of discharge port surfaces 2b from which ink is discharged. FIG. 9 is a drawing illustrating part of an ink jet recording apparatus 40 as the liquid discharge apparatus.

A lower surface of the ink jet head 1 is provided with element substrates 2 formed with discharge ports 2a from which ink is discharged. The element substrates 2 each includes a plurality of discharge port rows including a plurality of the discharge ports 2a are disposed in the direction indicated by an arrow A illustrated in FIG. 1A.

The ink jet head 1 also includes the tank holder 3 as a load section on which a plurality of ink tanks 20 (FIG. 9) are loaded. Side walls 32 of the tank holder 3 are each provided with a rough guide 33 (guiding member) being a projection protruding from the side walls 32 and having a guide surface 331. A portion of the tank holder 3 where the ink tanks 20 are loaded is partitioned by a plurality of a partitioning walls 31, that is, the plurality of partitioning walls 31 are located between the adjacent ink tanks 20 in a state in which the ink tanks 20 are loaded. Inks supplied from the ink tanks 20 are supplied to the element substrates 2 through filters 7.

The ink jet head 1 is mounted in a carriage 41 (mount section) provided on the ink jet recording apparatus 40, and is scanned in the main scanning direction, which is the direction of movement of the carriage 41 (in the direction indicated by an arrow B illustrated in FIG. 1A). Recording is performed by discharging ink from the discharge ports 2a while the ink jet head 1 is scanned in the main scanning direction with respect to a recording medium such as paper conveyed in the sub-scanning direction(the direction indicated by the arrow A in FIG. 1A).

The sub-scanning direction is also referred to as a first direction, the direction intersecting the discharge port surfaces 2b (the direction vertical to the discharge port surfaces 2b in the first embodiment) is also referred to as a second direction, and the main scanning direction is also referred to as a third direction.

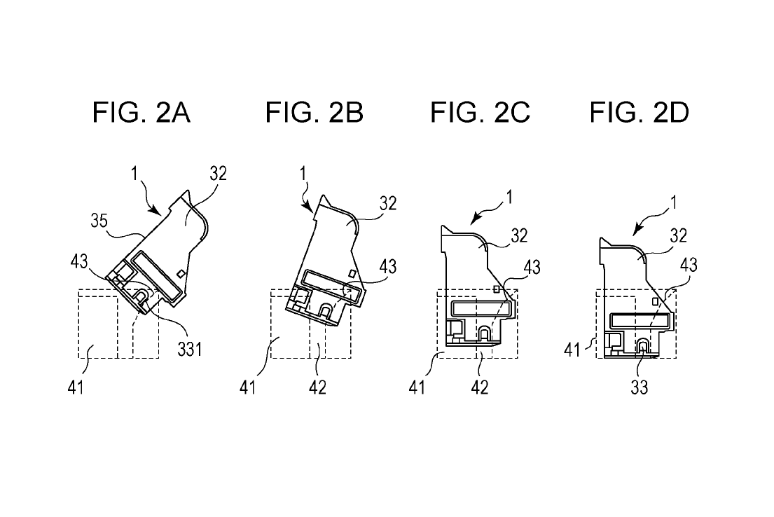

FIGS. 2A to 2D are drawings for explaining mounting of the ink jet head 1 of the first embodiment in the carriage 41, and are schematic drawings illustrating the ink jet head 1 and the carriage 41 viewed from the side of the side wall 32 of the tank holder 3. In these drawings, part of the ink jet head 1 is illustrated so as to be seen through.

As illustrated in FIG. 2A, when mounting the ink jet head 1 in the carriage 41, the ink jet head 1 is held in an inclined posture, and the rough guide 33 provided on the tank holder 3 is inserted into a head accommodation area of the carriage 41 as a first step. A preferable posture of the ink jet head 1 at this time is a posture in which the side where the rough guide 33 is provided is inclined downward so that the rough guide 33 enters the head accommodation area of the carriage 41 prior to other portions.

As illustrated in FIGS. 2A to 2D, the guide surface 331 of the rough guide 33 is engaged with an inclined surface 43 of a guide groove 42 of the carriage 41 and is slid along the guide groove 42, whereby the ink jet head 1 is mounted in the carriage 41. FIG. 2D shows a state in which mounting of the ink jet head 1 in the carriage 41 is completed.

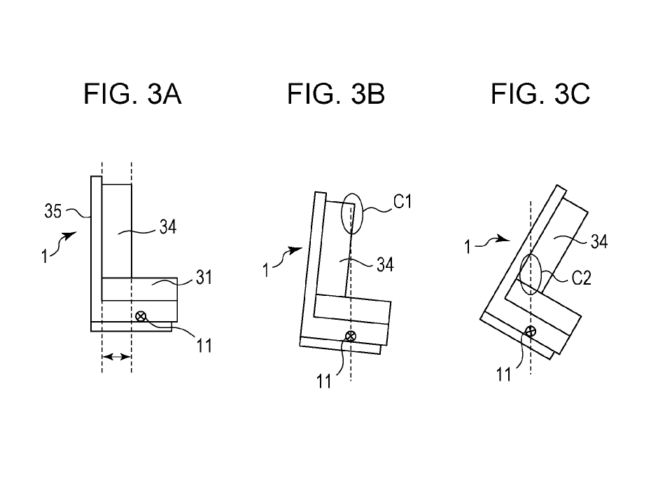

FIGS. 3A to 3C are schematic cross-sectional views of the ink jet head 1 of the first embodiment taken along a plane including a grasp portion 34 described later. FIG. 3A illustrates a posture of the ink jet head 1 after the mounting in the carriage 41 is completed and being ready to be used. FIGS. 3B and 3C are drawings for explaining the posture of the ink jet head 1 in a state in which the user grasps the grasp portion 34 of the ink jet head 1, and reference signs C1 and C2 in the respective drawings indicate a grasp positions by the user.

As illustrated in FIG. 1, the tank holder 3 of the ink jet head 1 is provided with the grasp portion 34 used by the user for grasping the ink jet head 1. The grasp portion 34 extends along the sub-scanning direction (the direction of disposition of the discharge ports 2a) as the first direction, and includes a surface extending along the direction intersecting the discharge port surfaces 2b as the second direction (the vertical direction in the first embodiment). The grasp portion 34 is provided on the top of the partitioning wall 31 formed at a center portion in the main scanning direction as the third direction from among nine of the partitioning walls 31 so as to continue therefrom.

Here, as illustrated in FIG. 3A, a center of gravity 11 of the ink jet head 1 in the sub-scanning direction is located at a position deviated from an area just below the grasp portion 34. In other words, the grasp portion 34 is provided at a position not overlapped in the direction vertical to the discharge port surfaces 2b with a center axis passing in the main scanning direction as the third direction through the center of gravity 11 of the ink jet head 1 in the sub-scanning direction as the first direction.

In the first embodiment, assuming that a back wall 35 side of the tank holder 3 is the back side, and the opening side is the near side, the center of gravity 11 is located on the near side with respect to the grasp portion 34. Accordingly, the ink jet head 1 takes a posture inclining toward the near side irrespective of the positions of the grasp portion 3 grasped by the user as illustrated in FIGS. 3B and 3C. In this manner, since the ink jet head 1 inclines in a definite direction, the posture of the ink jet head 1 when being mounted may be stabilized.

As illustrated in FIG. 2D, the rough guide 33 is provided on a lower portion on the near side of the outline of the side wall 32 (the side surface) of the tank holder 3 when viewed from the main scanning direction. Specifically, the guide surface 331 of the rough guide 33 is provided at a position on the near side with respect to the center of the outline of the tank holder 3 in the sub-scanning direction. Also, the rough guide 33 is provided so that the position of the guide surface 331 with respect to the center of gravity 11 is on the side opposite to the position of the grasp portion 34 with respect to the center of gravity 11 in the sub-scanning direction.

Accordingly, the ink jet head 1 takes a posture inclining toward the side where the rough guide 33 is provided (the near side in the first embodiment) irrespective of the positions of the grasp portion 34 grasped by the user. It is the posture inclined in the direction along the inclined surface 43 on which the guide groove 42 of the carriage 41 is formed. Therefore, since the rough guide 33 can be inserted into the head accommodation area of the carriage 41 prior to other portions when mounting in the carriage 41 is started, the ink jet head 1 may be mounted smoothly in the carriage 41.

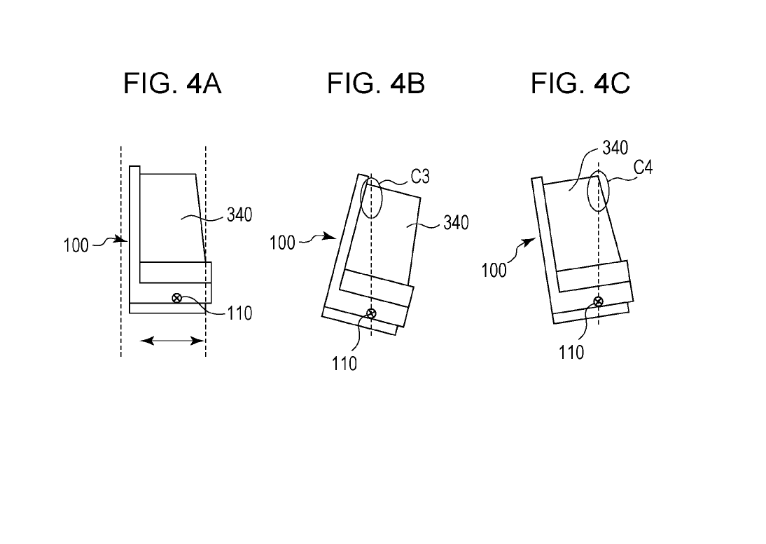

FIGS. 4A to 4C are schematic cross-sectional views taken along a plane including a grasp portion 340 of an ink jet head 100 of a comparative example. FIG. 4A illustrates a posture of the ink jet head 100 after the mounting in the carriage 41 is completed and being ready to be used. FIGS. 4B and 4C are drawings for explaining the posture of the ink jet head 100 in a state in which the user grasps the grasp portion 340 of the ink jet head 100, and reference signs C3 and C4 in the respective drawings indicate the grasp positions by the user.

In this comparative example, the surface area of the grasp portion 340 is larger than that is the first embodiment, and the center of gravity 110 of the ink jet head 100 in the sub-scanning direction is at a position where the grasp portion 340 is included in an area just below. In this case, as illustrated in FIGS. 4B and 4C, the direction of inclination of the ink jet head 100 is changed depending on the grasp positions C3 and C4 of the grasp portion 340 where the user grasps. Therefore, the posture of the ink jet head 100 may become unstable when mounting the ink jet head 100. In addition, depending on the grasp position, the ink jet head 100 may take a position inclined to the side opposite to the rough guide side, whereby the smooth mounting of the ink jet head 100 may not be performed.

As described above, in the first embodiment, the center of gravity 11 of the ink jet head 1 in the sub-scanning direction is at a position deviated from the area just below the grasp portion 34 unlike the comparative example. Therefore, the posture of the ink jet head 1 when the ink jet head 1 is mounted in the carriage 41 may be stabilized, so that smooth mounting is achieved.

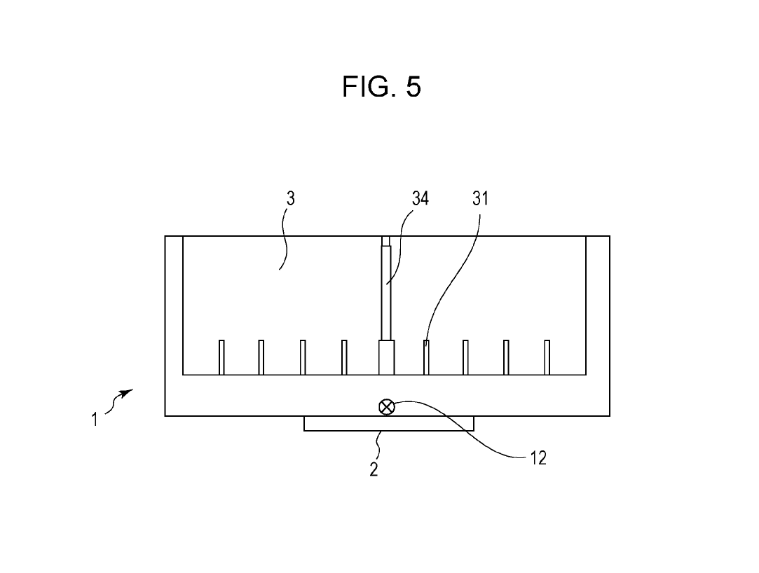

FIG. 5 is a schematic drawing of the ink jet head 1 of the first embodiment viewed from the near side in the sub-scanning direction illustrating the positional relationship between a center of gravity 12 of the ink jet head 1 and the grasp portion 34 in the main scanning direction.

In the first embodiment, the ink jet head 1 has a shape symmetry with respect to a center in the main scanning direction. In other words, the center of gravity 12 of the ink jet head 1 in the main scanning direction is located just below the grasp portion 34.

Therefore, moment about the center axis passing through the center of gravity 12 of the ink jet head 1 in the sub-scanning direction is zero. In other words, the moment around the center axis passing through the center of gravity 12 in the sub-scanning direction is smaller than the moment about the center axis passing through the center of gravity 11 in the main scanning direction of the ink jet head 1 in the sub-scanning direction.

Accordingly, since a force required for the user for correcting the inclination about the center axis passing through the center of gravity 12 in the sub-scanning direction when mounting the ink jet head 1 may be reduced, the posture of the ink jet head 1 can easily be stabilized. Therefore, further improvement of mountability of the ink jet head 1 with respect to the carriage 41 is achieved. In particular, such a configuration is effective in a mode in which the width in the main scanning direction is large as in the ink jet head 1 of the first embodiment.

The first embodiment is a mode in which the width in the direction of disposition of the ink tank 20 (the main scanning direction in the first embodiment) is large because a relatively large number of ink tanks 20 are to be loaded. In this case, it is probable that the user has a difficulty to grasp the both side walls 32 of the ink jet head 1 with one hand, or the ink jet head 1 may be inclined significantly in the direction of disposition of the ink tanks 20 when the user grasps the side wall 32 on one side. Therefore, a provision of the grasp portion 34 at a center portion in the direction of disposition of the ink tanks 20, which is a longitudinal direction of the ink jet head 1 as in the first embodiment, allows the user to grasp the ink jet head 1 easily, and easy stabilization of the posture of the ink jet head 1 is achieved.

In the case of the ink jet head 1 having a width on the order of allowing the user to grasp the both side walls 32 of the ink the head 1 with one hand, the grasp portion 34 may be formed so as to have a positional relationship with respect to the center of gravity 11 illustrated in FIG. 3A when using the side walls 32 as the grasp portion 34.

### Second Embodiment

The first embodiment has a configuration in which the center of gravity 11 is located on the near side of the ink jet head 1 with respect to the grasp portion 34 in the sub-scanning direction, while a second embodiment has a configuration in which the center of gravity 11 is located on the back side with respect to the grasp portion 34. Hereinafter, arrangement of the center of gravity 11, the rough guide 33, and the grasp portion 34 of the ink jet head 1 of the second embodiment will be described. Configurations which are not described below are the same as those in the first embodiment described above.

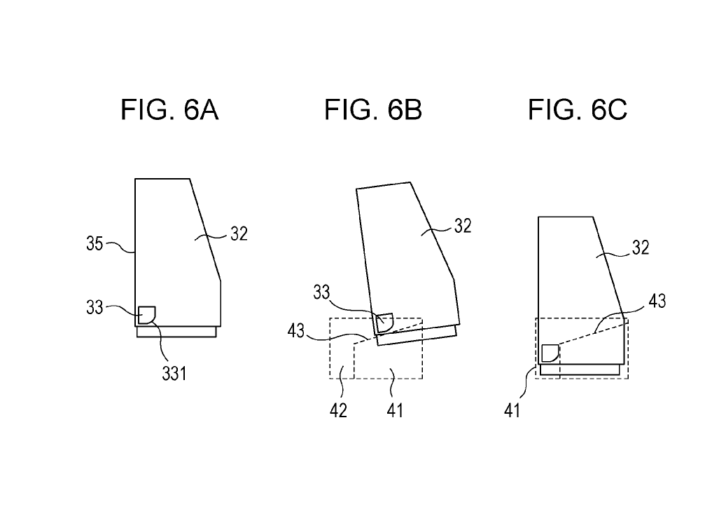

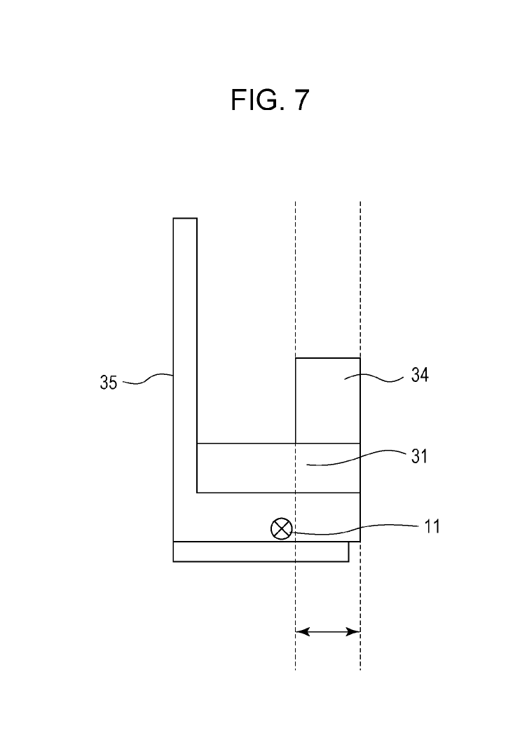

FIG. 6A is a schematic drawing illustrating the ink jet head 1 viewed from the side of the side wall 32 of the ink jet head 1 of the second embodiment. FIGS. 6B and 6C are drawings for explaining mounting of the ink jet head 1 in the carriage 41, and part of the ink jet head 1 is seen through. FIG. 7 is a schematic cross-sectional view of the ink jet head 1 of the second embodiment taken along a plane including a grasp portion 34.

In the second embodiment as well, the center of gravity 11 of the ink jet head 1 in the sub-scanning direction is located at a position deviated from the area just below the grasp portion 34. In other words, the grasp portion 34 is provided at a position not overlapped in the direction vertical to the discharge port surfaces 2b with the center axis passing in the main scanning direction as the third direction through the center of gravity 11 of the ink jet head 1 in the sub-scanning direction as the first direction. Specifically, as illustrated in FIG. 7, the center of gravity 11 is located on the side of the back wall 35 (the back side) with respect to the grasp portion 34.

Accordingly, the ink jet head 1 takes a posture inclining toward the back side irrespective of the positions of the grasp portion 34 grasped by the user. In this manner, since the ink jet head 1 inclines in a definite direction, the posture of the ink jet head 1 when being mounted may be stabilized.

As illustrated in FIG. 6A, the rough guide 33 is provided on the lower portion near the back side of the outline of the side wall 32 (the side surface) of the tank holder 3 when viewed from the main scanning direction. Specifically, the guide surface 331 of the rough guide 33 is provided at a position on the back side with respect to the center of the outline of the tank holder 3 in the sub-scanning direction. Also, the rough guide 33 is provided so that the position of the guide surface 331 with respect to the center of gravity 11 is on the side opposite to the position of the grasp portion 34 with respect to the center of gravity 11 in the sub-scanning direction.

Accordingly, the ink jet head 1 takes a posture inclining toward the side where the rough guide 33 is provided (the back side in the second embodiment) irrespective of the positions of the grasp portion 34 grasped by the user. Therefore, since the rough guide 33 can be inserted into the head accommodation area of the carriage 41 prior to other portions when mounting in the carriage 41 is started (FIG. 6B), the ink jet head 1 may be mounted smoothly in the carriage 41.

### Third Embodiment

A third embodiment has a configuration in which a heat radiating panel 5 is provided on the ink jet head 1 of the first embodiment. With a provision of the heat radiating panel 5 having a high thermal conductivity, a temperature rise of the element substrates 2 is suppressed, and occurrence of ink discharge failure or uneven printing in association with the temperature rise of the ink may be suppressed.

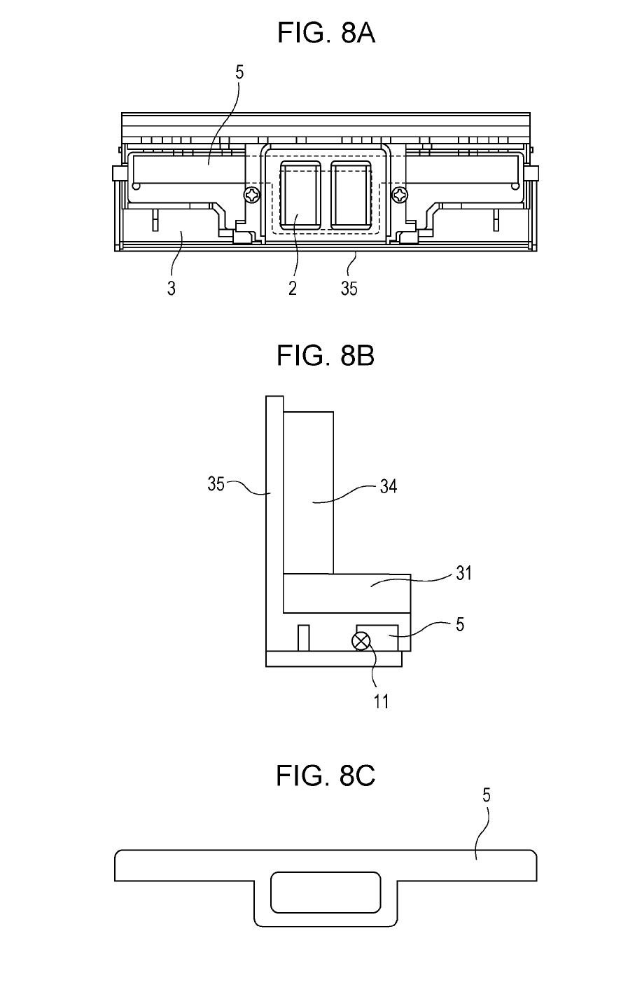

FIGS. 8A to 8C are drawings illustrating the ink jet head 1 of the third embodiment. FIG. 8A is a bottom view of the ink jet head 1, FIG. 8B is a schematic cross-sectional view of the ink jet head 1 taken along a plane including the grasp portion 34, and FIG. 8C is a drawing illustrating the heat radiating panel 5.

The heat radiating panel 5 has a shape in which the center of gravity is deviated to the near side of the ink jet head 1. Since the heat radiating panel 5 having such a shape is provided on the back side of the element substrates 2, the center of gravity 11 of the ink jet head 1 is located on the nearer side of the ink jet head 1 than the case of the first embodiment. Therefore, the configuration of the third embodiment is effective in a case where the inclination of the ink jet head 1 needs to be increased, or a case where the position to provide the grasp portion 34 is limited. The position of the center of gravity 11 of the ink jet head 1 may be adjusted by the arrangement or the shape of the member such as the heat radiating panel 5 as in the third embodiment.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-124834 filed May 31, 2012, which is hereby incorporated by reference herein in its entirety.

What is claimed is:

1. A liquid discharge head comprising:
a discharge port surface in which a plurality of discharge ports configured to discharge liquid are disposed along a first direction; and
a grasp portion including a surface extending along the first direction and a second direction intersecting the discharge port surface and used for grasping the liquid discharge head,
wherein the surface of the grasp portion is provided at a position not overlapped in a direction vertical to the discharge port surface with a center axis passing in a third direction, which is vertical to the first direction and extending along the discharge port surface through the center of gravity of the liquid discharge head in the first direction.

2. The liquid discharge head according to claim 1; wherein a guiding member is provided on a side surface of the liquid discharge head in the third direction and configured to guide mounting of the liquid discharge head on a mount section on which the liquid discharge head is mounted, the surface of the grasp portion and at least part of the guiding member are located at positions opposite to each other in the first direction with respect to the center axis passing through the center of gravity of the liquid discharge head in the first direction.

3. The liquid discharge head according to claim 2, wherein the guiding member engages a surface of the mount section and guides mounting of the liquid discharge head with respect to the mount section.

4. The liquid discharge head according to claim 3, wherein the liquid discharge head is inclined to a state extending along the surface of the mount section in comparison with mounting of the liquid discharge head to the mount section is completed in a state in which the grasp portion is grasped.

5. The liquid discharge head according to claim 1, wherein the grasp portion is provided at a center portion in the third direction of the liquid discharge head.

6. The liquid discharge head according to claim 1, comprising a load section on which a plurality of tanks that accommodate a liquid to be supplied to the liquid discharge head are loaded in the third direction, the load section including a partitioning wall provided between the tanks loaded adjacently,
wherein the grasp portion is provided so as to continue from the partitioning wall.

7. The liquid discharge head according to claim 1, wherein the grasp portion is a side surface of the liquid discharge head in the third direction.

8. The liquid discharge head according to claim 1, wherein the surface of the grasp portion is provided at a position overlapped in the direction vertical to the discharge port surface with a center axis passing along the first direction through the center of gravity of the liquid discharge head in the third direction.

9. A liquid discharge head comprising:
a discharge port surface in which a discharge port configured to discharge liquid is disposed;
a grasp portion including a surface extending along a first direction as a direction vertical to a longitudinal direction of the liquid discharge head and a second direction intersecting the discharge port surface, and used for grasping the liquid discharge head,
wherein the surface of the grasp portion is provided at a position not overlapped in a direction vertical to the discharge port surface with a center axis passing along the longitudinal direction through the center of gravity of the liquid discharge head in the first direction.

10. The liquid discharge head according to claim 9, comprising a guiding member provided on a side surface of the liquid discharge head in the longitudinal direction and configured to guide mounting of the liquid discharge head on a mount section on which the liquid discharge head is mounted, wherein the surface of the grasp portion and at least part of the guiding member are located at positions opposite to each other in the first direction with respect to the center axis passing through the center of gravity of the liquid discharge head in the first direction.

11. The liquid discharge head according to claim 10, wherein the guiding member engages a surface of the mount section and guide mounting of the liquid discharge head with respect to the mount section.

12. The liquid discharge head according to claim 11, wherein the liquid discharge head is inclined to a state extending along the surface of the mount section in comparison with a state in which mounting of the liquid discharge head to the mount section is completed in a state in which the grasp portion is grasped.

13. The liquid discharge head according to claim 9, wherein the grasp portion is provided at a center portion in the longitudinal direction of the liquid discharge head.

14. The liquid discharge head according to claim 9, comprising: a load section on which a plurality of tanks that accommodate a liquid to be supplied to the liquid discharge head are loaded in the longitudinal direction, the load section including a partitioning wall provided between the tanks loaded adjacently,
wherein the grasp portion is provided so as to continue from the partitioning wall.

15. The liquid discharge head according to claim 9, wherein the grasp portion is a side surface of the liquid discharge head in the longitudinal direction.

16. The liquid discharge head according to claim 9, wherein the surface of the grasp portion is provided at a position overlapped in the direction vertical to the discharge port surface with a center axis passing along the first direction through the center of gravity of the liquid discharge head in the longitudinal direction.

17. A liquid discharge apparatus comprising:
a liquid discharge head including: a discharge port surface in which a plurality of discharge ports configured to discharge liquid are disposed along a first direction; and a grasp portion including a surface extending along the first direction and a second direction intersecting the discharge port surface and used for grasping the liquid discharge head,
a mount section on which the liquid discharge head is mounted;
wherein the surface of the grasp portion is provided at a position not overlapped in a direction vertical to the discharge port surface with a center axis passing along a third direction which is vertical to the first direction and extending along the discharge port surface through the center of gravity of the liquid discharge head in the first direction.

18. The liquid discharging apparatus according to claim 17, comprising a guiding member provided on a side surface of the liquid discharge had in the third direction and configured to guide mounting of the liquid discharge head on a mount section, wherein the surface of the grasp portion and at least part of the guiding member are located at positions opposite to each other in the first direction with respect to the center axis passing through the center of gravity in the first direction, and
the mount section is provided with a surface engaging the guiding member.

19. A liquid discharge apparatus comprising:
a liquid discharge head including a discharge port surface in which a discharge port configured to discharge liquid are disposed; and a grasp portion including a surface extending along a first direction as a direction vertical to the longitudinal direction of the liquid discharge head and a second direction intersecting the discharge port surface and used for grasping the liquid discharge head,
a mount section on which the liquid discharge head is mounted
wherein the surface of the grasp portion is provided at a position not overlapped in a direction vertical to the discharge port surface with a center axis passing along the longitudinal direction through the center of gravity of the liquid discharge head in the first direction.

20. The liquid discharge apparatus according to claim 19, comprising a guiding member provided on a side surface of the liquid discharge head in the longitudinal direction and configured to guide mounting of the liquid discharge head on a mount section, wherein the surface of the grasp portion and at least part of the guiding member are located at positions opposite to each other in the first direction with respect to the center axis passing through the center of gravity in the first direction, and
the mount section is provided with a surface engaging the guiding member.
